(19) United States
(12) Patent Application Publication
(10) Pub. No.: US 2016/0196893 A1
(43) Pub. Date: Jul. 7, 2016

(54) METHOD FOR PREPARING TWO-DIMENSIONAL MATERIAL

(71) Applicant: NATIONAL CHIAO TUNG UNIVERSITY, Hsinchu City (TW)

(72) Inventors: Fang-Chung CHEN, Nantou County (TW); Wai-Chen LIN, Miaoli County (TW)

(21) Appl. No.: 14/710,577

(22) Filed: May 12, 2015

(30) Foreign Application Priority Data
Jan. 5, 2015 (TW) 104100108

(51) Int. Cl. H01B 1/24

(52) U.S. Cl. CPC H01B 1/24

(57) ABSTRACT

A method for preparing a two-dimensional material includes adding a three-dimensional layered material into a solvent to form a three-dimensional layered material dispersion. Then, the three-dimensional layered material dispersion is irradiated by light to exfoliate the three-dimensional layered material to produce the two-dimensional material suspending in the solvent. The light has a wavelength of 100-1500 nm, and the irradiation time is 0.5-5 hours.

### RELATED APPLICATIONS

This application claims priority to Taiwanese Application Serial Number 104100108, filed Jan. 5, 2015, which is herein incorporated by reference.

### BACKGROUND

1. Field of Invention

The present invention relates to a method for preparing a two-dimensional material. More particularly, the present invention relates to a method for preparing a two-dimensional material from a three-dimensional layered material.

2. Description of Related Art

Two-dimensional materials have received extensive attention worldwide, and such material has various applications. For instance, the two-dimensional material can be applied to make elements, such as transparent conductive substrates, transistors and photodetectors. These elements are widely existed in today's electronic products, such as computers, mobile phones and displays. The two-dimensional material also can be used as an electrode material or catalyst, and is an important basic component of a secondary battery.

Currently, a variety of preparing methods for the two-dimensional material have been developed, such as chemical vapor deposition and epitaxial growth. Although these methods have high quality, they are not suitable for mass production, and the costs are high. Other method such as a liquid-phase exfoliation method has low costs, but the efficiency is still low, and is typically time-consuming. In addition, it has been proposed that using laser irradiation also can achieve the purpose of producing the two-dimensional material by exfoliation. However, this technique requires an expensive machine, and the focus of the laser irradiation is too small. Hence, using laser irradiation is still not suitable for mass production.

Accordingly, there is a need for a method for preparing the two-dimensional material, which has advantages of time-saving, a simple process, a low cost, being capable of mass production, etc.

### SUMMARY

The invention provides a method for preparing a two-dimensional material, including adding a three-dimensional layered material into a solvent to form a three-dimensional layered material dispersion. Then, the three-dimensional layered material dispersion is irradiated by light to exfoliate the three-dimensional layered material to produce the two-dimensional material suspending in the solvent. The light has a wavelength of 100-1500 nm, and the irradiation time is 0.5-5 hours.

According to an embodiment of the present invention, the three-dimensional layered material is graphite, transition metal dichalcogenide, transition metal trichalcogenide, h-BN, transition metal halide, III-VI layered semiconductor, zirconium phosphonate, layered silicate, layered double hydroxide, ternary transition metal carbide or ternary transition metal nitride.

According to an embodiment of the present invention, the three-dimensional layered material is graphite, and the wavelength of the light is 100-400 nm.

According to an embodiment of the present invention, the solvent is N-methyl-2-pyrrolidone, N,N-dimethylformamide, 1,3-dimethyl-2-imidazolidinone, cyclohexanone, benzylamin, propylene carbonate, γ-butyrolactone or a combination thereof.

According to an embodiment of the present invention, the three-dimensional layered material dispersion has a concentration of 0.1-10 mg/mL.

According to an embodiment of the present invention, the irradiation time is 1-4 hour(s).

According to an embodiment of the present invention, the two-dimensional material has a thickness of 0.03-500 nm.

According to an embodiment of the present invention, the method for preparing a two-dimensional material further includes adding a surfactant to form the three-dimensional layered material dispersion.

According to an embodiment of the present invention, the method for preparing a two-dimensional material further includes adding a cosolvent to form the three-dimensional layered material dispersion.

According to an embodiment of the present invention, the method for preparing a two-dimensional material further includes a centrifuging step to separate the two-dimensional material.

The method for preparing a two-dimensional material of the present invention utilizes the light to irradiate the three-dimensional layered material, which absorbs the light and converts light energy into molecular vibrational energy of each layered structure. The structure of the three-dimensional layered material thus becomes loose, and thereby exfoliating the three-dimensional layered material to produce the two-dimensional material that is a thin two-dimensional material nanosheet.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is a flowchart of a method for preparing a two-dimensional material according to an embodiment of the present invention.

FIGS. 2A and 2B are Raman spectra of two-dimensional materials of an embodiment of the present invention and a comparative example.

FIGS. 3A and 3B are atomic force microscopy images of two-dimensional materials of an embodiment of the present invention and a comparative example respectively.

FIGS. 3C and 3D are thickness-measuring graphs of FIGS. 3A and 3B respectively.

FIGS. 4A and 4B are transmission electron microscopy images of a two-dimensional material of a comparative example.

FIGS. 5A and 5B are transmission electron microscopy images of a two-dimensional material of an embodiment of the present invention.

FIGS. 6A through 6D are resulting images of three-dimensional layered material dispersions irradiated by different lights.

FIG. 7A is a schematic structural diagram of an inverted solar cell.

FIG. 7B is a current density vs. voltage graph of inverted solar cells using two-dimensional materials of an embodiment of the present invention and a comparative example as a material of an anode buffer layer independently.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples. Therefore, the spirit and scope of the appended claims should not be limited to the description of the embodiments contained herein.

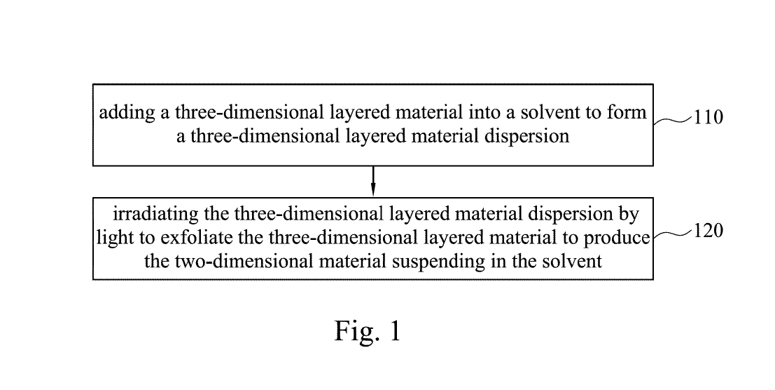

FIG. 1 is a flowchart of a method for preparing a two-dimensional material according to an embodiment of the present invention. First, a three-dimensional layered material is added into a solvent to form a three-dimensional layered material dispersion (Step 110). Then, the three-dimensional layered material dispersion is irradiated by light to exfoliate the three-dimensional layered material to produce the two-dimensional material suspending in the solvent (Step 120). The light has a wavelength of 100-1500 nm, and the irradiation time is 0.5-5 hours. The light may be ultraviolet (UV, Wavelength: 100-400 nm), visible light (Wavelength: 400-700 nm) or infrared (IR, Wavelength: 700-1500 nm).

A three-dimensional layered material represents a bulk composed of multiple atomic layers of two-dimensional materials. The three-dimensional layered material used in the present invention may be graphite, transition metal dichalcogenide (TMD), transition metal trichalcogenide (TMD), h-BN, transition metal halide, III-VI layered semiconductor, zirconium phosphonate, layered silicate, layered double hydroxide (LDH), ternary transition metal carbide or ternary transition metal nitride.

The “graphite” used herein may represent graphite or derivatives thereof, such as halogenated graphite. The TMD may be MoS₂ [symbol] AMo₃X₃.NbX₃.TiX₃ or TaX₃, wherein X═S, Se or Te. The transition metal halide may be titanium oxide, niobium oxide, manganese oxide, birnessite, trioxide (e.g. MoO₃, TaO₃ and hydrated WO₃), perovskite or oxyhalide of transition metal (e.g. VOCl.CrOCl.FeOCl.NbO₂F.WO₂Cl₂ and FeMoO₄Cl). The III-VI layered semiconductor may be GaX or InX, wherein X═S, Se or Te. The ternary transition metal carbide and the ternary transition metal nitride are derivatives of MAX phase, wherein M=transition metal, A=Al or Si, and X=C or N.

When the three-dimensional layered material is graphite, because the graphite absorbs UV, the light used to irradiate the three-dimensional layered material dispersion in step 120 is UV having a wavelength in a range of 100-400 nm, such as 230-280 nm, 280-315 nm and 315-400 nm.

In accordance with an embodiment of the present invention, the solvent is N-methyl-2-pyrrolidone (NMP), N,N-dimethylformamide (DMF), 1,3-dimethyl-2-imidazolidinone (DMI), cyclohexanone (CYC), benzylamin (BA), propylene carbonate (PC), γ-butyrolactone (GBL) or a combination thereof.

In accordance with an embodiment of the present invention, the three-dimensional layered material dispersion has a concentration of 0.1-10 mg/mL, such as 0.1, 0.5, 1, 1.5, 2, 2.5, 3, 3.5, 4, 4.5, 5, 5.5, 6, 6.5, 7, 7.5, 8, 8.5, 9, 9.5 or 10 mg/mL.

In accordance with an embodiment of the present invention, in step 110, a surfactant may be additionally added to form the three-dimensional layered material dispersion. In the process of the three-dimensional layered material dispersion being irradiated by the light of the present invention, the surfactant may enter the space between the layers of the three-dimensional layered material, which makes it easier to exfoliate the three-dimensional layered material. Examples of the surfactant include but are not limited to 1-butyl-3-methylimidazolium bromide and ammonium perfluorooctanoate.

In accordance with an embodiment of the present invention, in step 110, a cosolvent may be additionally added to form the three-dimensional layered material dispersion. The role of the cosolvent is an auxiliary solvent that enhances the solvent power of the primary solvent. In the process of the three-dimensional layered material dispersion being irradiated by the light of the present invention, the cosolvent may enter the space between the layers of the three-dimensional layered material, which makes it easier to produce the two-dimensional material exfoliated from the three-dimensional layered material. The cosolvent may be a small molecule solvent, such as N-methylpyrrolidone, toluene, hexane, ethanol, acetone and ether.

In step 120, the duration of the three-dimensional layered material dispersion irradiated by the light, i.e. irradiation time, is related to the electric power in watts of the light source, i.e. wattage. The light source used in the present invention may has a wattage of 100-10000 watts (W), such as 100-1000, 1000-2000, 2000-3000, 3000-4000, 4000-5000, 5000-6000, 6000-7000, 7000-8000, 8000-9000 or 9000-10000 W. When the wattage of the light source is higher, the power is higher, and thus the irradiation time for exfoliating the three-dimensional layered material to produce the two-dimensional material is shorter. While when the wattage of the light source is lower, the power is lower, and thus the irradiation time for exfoliating the three-dimensional layered material to produce the two-dimensional material is longer. In accordance with an embodiment of the present invention, the irradiation time is 0.5-5 hours, preferably 1-4 hour(s). For instance, the irradiation time may be 0.5, 1, 1.5, 2, 2.5, 3, 3.5, 4, 4.5 or 5 hour(s).

It is noteworthy that when the three-dimensional layered material dispersion is irradiated by the light, the three-dimensional layered material dispersion may be stirred, which helps the two-dimensional material be exfoliated from the three-dimensional layered material. In some embodiments, the manner of stirring the three-dimensional layered material dispersion is adding a stirrer into the three-dimensional layered material dispersion, wherein the stirrer may be a magnetic stirrer, which is rotated by a device that is capable of generating magnetic force, and thereby stirring the three-dimensional layered material dispersion.

In accordance with an embodiment of the present invention, the two-dimensional material prepared by the method of the present invention includes monoatomic layer of two-dimensional material or few atomic layers of two-dimensional material, and has a thickness in a range of 0.03-500 nm. The monolayered two-dimensional material may have a thickness of 0.03-1 nm, while the multilayered two-dimensional material may have a thickness of 1-500 nm.

The method for preparing the two-dimensional material may further include a centrifuging step after the step 120 to separate the two-dimensional material. After the three-dimensional layered material dispersion was irradiated by the light, there might be a part of the three-dimensional layered material not being exfoliated and two-dimensional material being exfoliated from the three-dimensional layered material suspending in the solvent. Therefore, the solvent having the suspended unexfoliated three-dimensional layered material and exfoliated two-dimensional material may be centrifuged to separate the two-dimensional material from the three-dimensional layered material by gravity. The two-dimensional material would be the supernatant. Moreover, after that, the supernatant containing the two-dimensional material may be pelleted by centrifugation and washed, and freeze-dried to remove residual solvent. The obtained two-dimensional material is in the form of powder.

The method for preparing the two-dimensional material of the present invention utilizes the light to provide energy to the three-dimensional layered material. The light energy is converted into the molecular vibrational energy of each layered structure of the three-dimensional layered material. After the three-dimensional layered material absorbed the light, the layered structure of which starts to expand, which enlargers the space between the each layered structure. Therefore, the structure of the three-dimensional layered material becomes loose, and thereby exfoliating the three-dimensional layered material to produce the thin two-dimensional material nanosheet that may be monolayer or multiplayer. The two-dimensional material nanosheet prepared by the method of the present invention can be applied to electronic products, displays, batteries, transistors, catalysts, etc. For instance, the two-dimensional material can be used as a material of an electron transport layer. Comparing to conventional techniques, the method for preparing the two-dimensional material of the present invention has advantages of a low cost, a simple and rapid process, high efficiency, being beneficial for mass production, etc.

The detailed description provided below is intended as a description of the present examples and is not intended to represent the only forms in which the present example may be constructed or utilized. Therefore, the spirit and scope of the appended claims should not be limited to the description of the embodiments contained herein.

Preparation of Two-Dimensional Material

Fluorinated graphite was used as the three-dimensional layered material in an embodiment of the method for preparing the two-dimensional material of the present invention to form fluorinated graphene nanosheet, the preparing method includes the following steps:
1. Fluorinated graphite powder was added into a solvent to form a fluorinated graphite dispersion with a concentration of 1 mg/mL. In this embodiment, the solvent was N-methyl-2-pyrrolidone (NMP).
2. The fluorinated graphite dispersion of step 1 was continuously stirred while irradiated by ultraviolet for 2 hours. When the color of the fluorinated graphite dispersion gradually became darker, it represented that the fluorinated graphene nanosheet was exfoliated from the surface of the fluorinated graphite, and was suspended in the solvent to form a fluorinated graphene nanosheet suspension. At this time, the fluorinated graphene nanosheet suspension included unexfoliated part of the three-dimensional fluorinated graphite and the exfoliated two-dimensional fluorinated graphene sheet. In this embodiment, the wattage of the light source was 500 W. In some embodiments, a stirrer can be added into the fluorinated graphite dispersion to facilitate the stirring, which the stirrer may be a magnetic stirrer.
3. A centrifuging step was performed to separate the fluorinated graphene nanosheet from the fluorinated graphene nanosheet suspension of step 2. The suspension was centrifuged at 1000 rpm to draw out impurities, and to improve the purity of the fluorinated graphene nanosheet suspension.
4. The supernatant of step 3 was centrifuged at 1000 rpm to pellet fluorinated graphene sheet. The fluorinated graphene sheet was washed by toluene. After being repeatedly centrifuged and washed for three times, the fluorinated graphene sheet was freeze-dried to remove residual solvent and to form fluorinated graphene powder of the embodiment of the present invention.

The preparing method of a comparative example included ultrasonic treatment of a fluorinated graphite dispersion with the same concentration using an ultrasonic bath for 8 hours. Then, the obtained fluorinated graphene was purified by the same manner to form fluorinated graphene powder as a sample for comparison.

### Experimental Example 1

### Structural Analysis

In this experimental example, fluorinated graphene solutions were prepared by adding the fluorinated graphene powder of the embodiment and the comparative example respectively. The structures of the samples were analyzed by Raman spectroscopy.

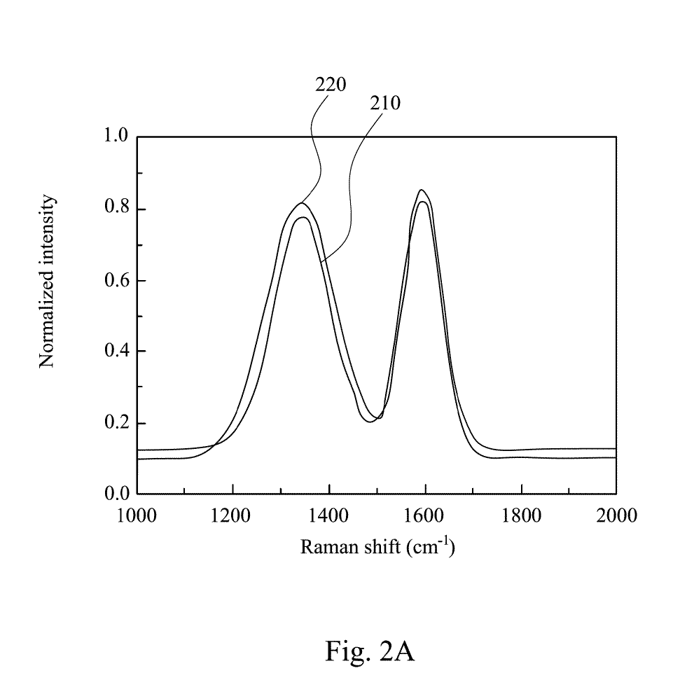

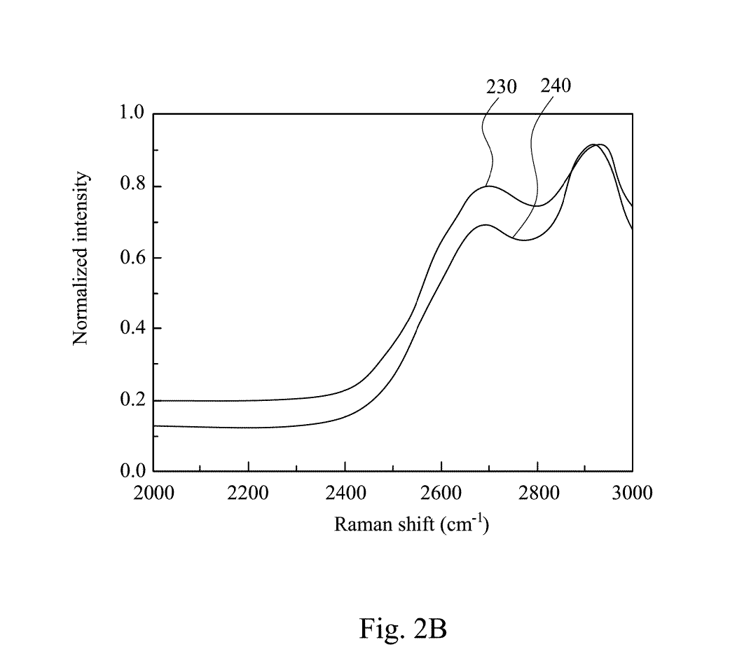

FIGS. 2A and 2B are Raman spectra of two-dimensional materials of an embodiment of the present invention and a comparative example, wherein lines 210 and 230 represent the Raman spectrum of the comparative example, and lines 220 and 240 represent the Raman spectrum of the embodiment. As shown in FIGS. 2A and 2B, typical peaks of the graphene in Raman spectroscopy can be observed in the Raman spectra of the two fluorinated graphene samples of the embodiment and the comparative example, including D-band located at about 1350 cm⁻¹, which is disorder-induced, and G-band located at about 1600 cm⁻¹, which is graphite-like. Further, 2D-band located at about 2700 cm⁻¹ can also be observed. These spectral characteristics represent that the embodiment of the present invention do have the structure of graphene. Further, the similar chemical structures of the embodiment and the comparative example represents that the preparing method of the present invention can exfoliate the three-dimensional layered graphite to produce two-dimensional graphene indeed. The preparing method of the present invention has similar effects to the conventional technique of ultrasonic treatment, but significantly reduces the time required for preparing the two-dimensional material.

### Experimental Example 2

### Thickness Analysis

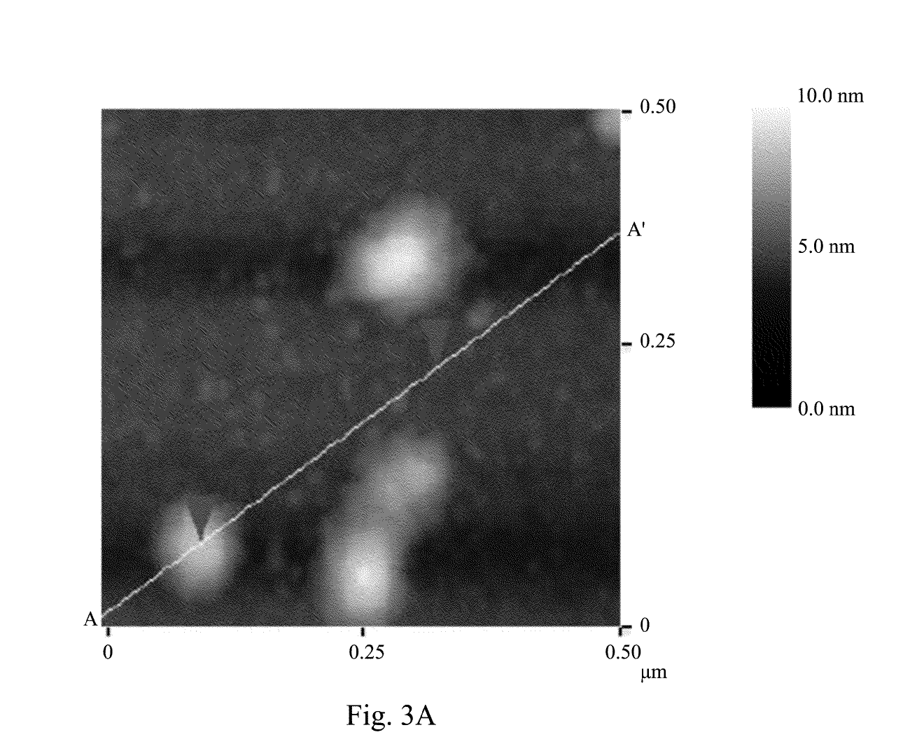

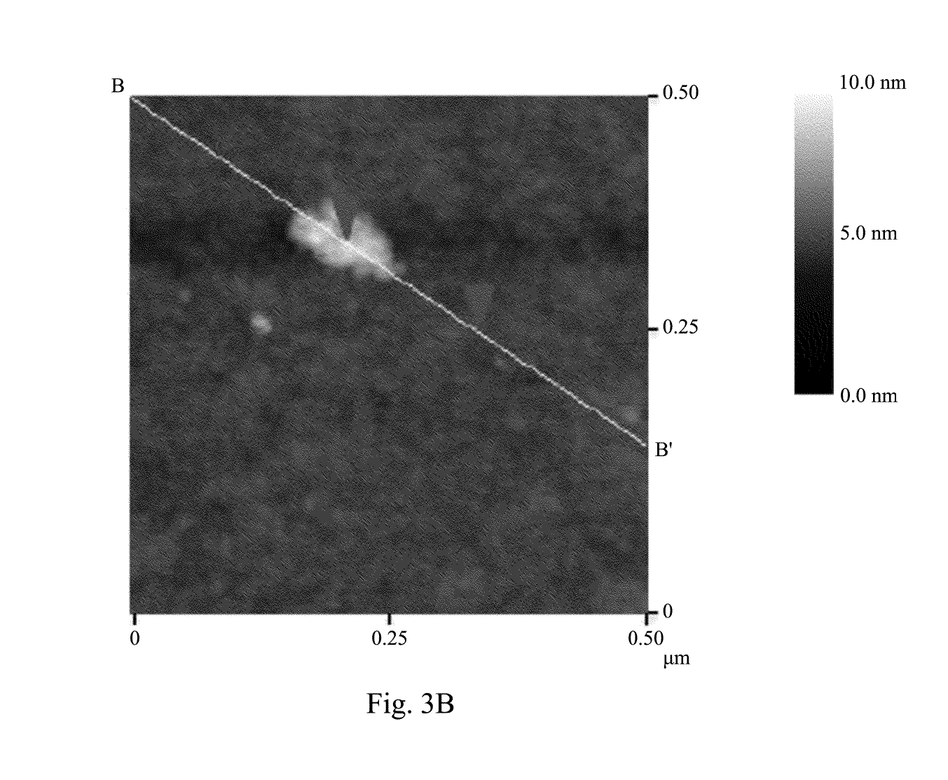

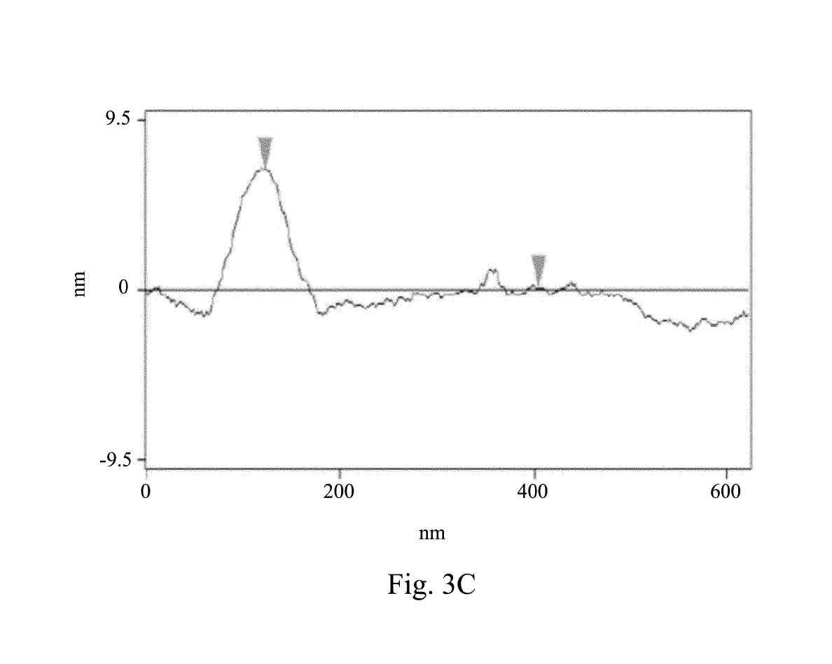

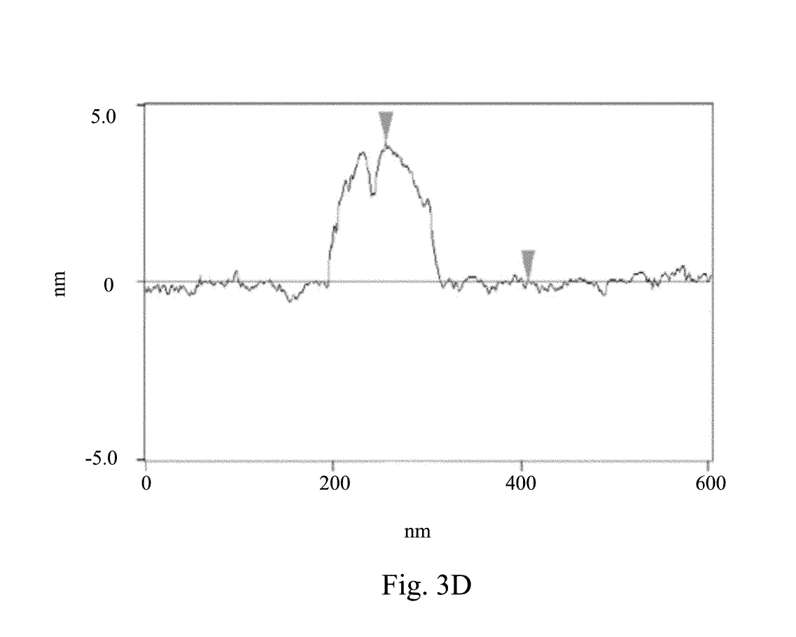

In this experimental example, the fluorinated graphenes of the embodiment and the comparative example were first deposited on a silicone wafer substrate, and the thicknesses of both were analyzed by an atomic force microscope (AFM). FIGS. 3A and 3B are AFM images of the two-dimensional fluorinated graphene of the embodiment of the present invention and the comparative example. FIG. 3C is a thickness-measuring graph along line A-A′ of FIG. 3A, and FIG. 3D is a thickness-measuring graph along line B-B′ of FIG. 3B. As shown in FIGS. 3A through 3D, the thickness of the fluorinated graphene of the comparative example that was prepared by ultrasonic treatment was about 6.65 nm, while the thickness of the fluorinated graphene of the embodiment that was prepared by UV irradiation was about 3.93 nm. Comparing to the conventional ultrasonic treatment technique, it can be observed through the analysis of the AFM that the fluorinated graphene obtained by the preparing method of the present invention, which utilizes the light irradiation, has a thinner thickness except for rapid process.

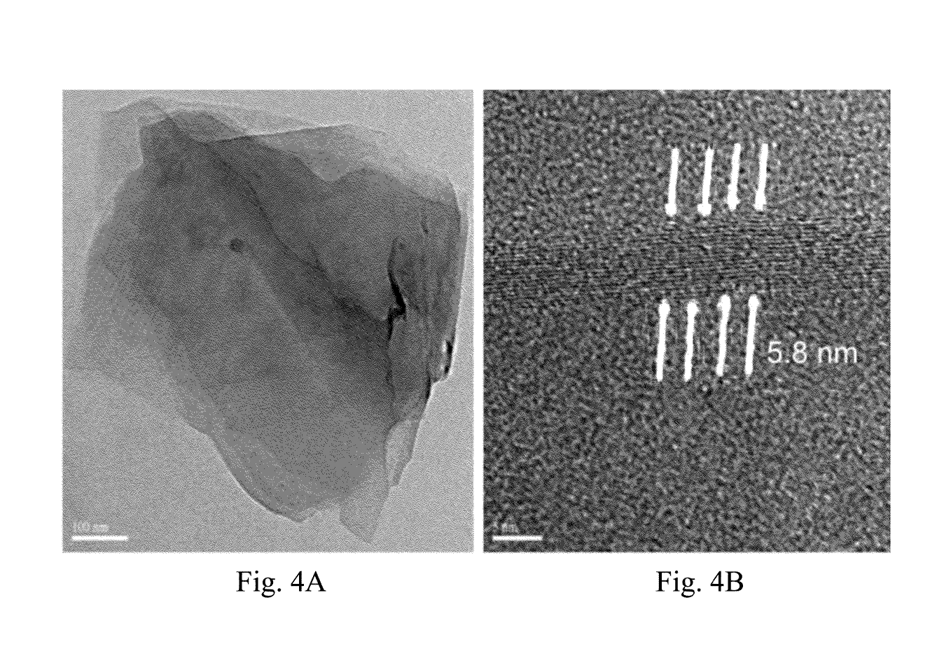

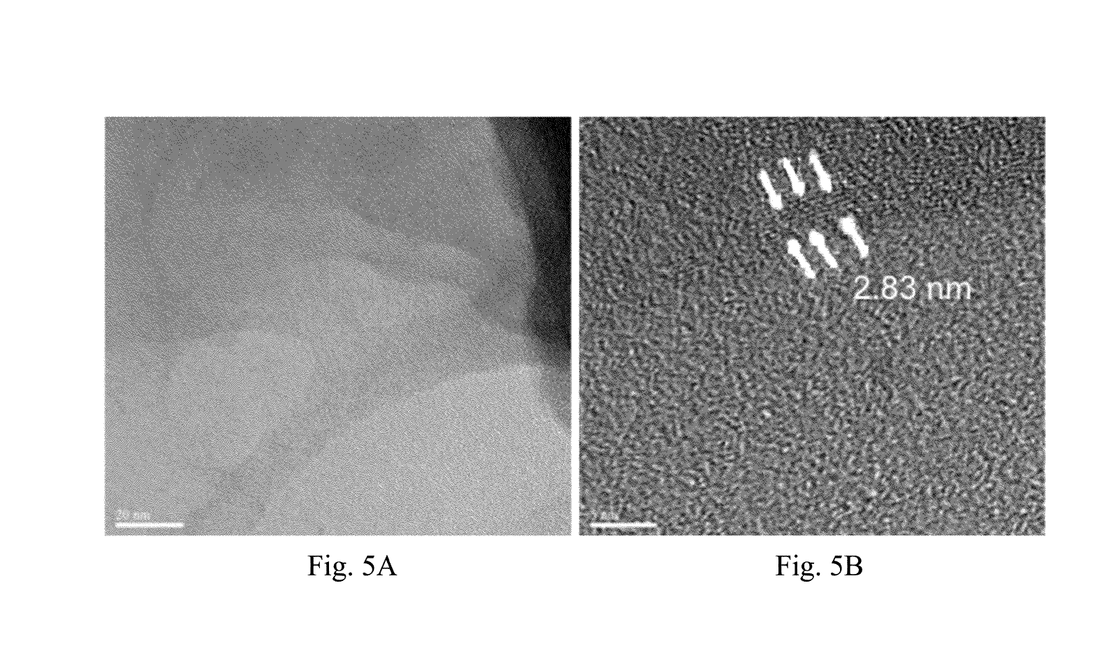

Further, a transmission electron microscope (TEM) was also used in the experimental example to observe the fluorinated graphene of the comparative example and the embodiment. Referring to FIGS. 4A, 4B, 5A and 5B, FIG. 4A is a TEM image of the fluorinated graphene of the comparative example, FIG. 4B is a partial enlarged view of FIG. 4A, FIG. 5A is a TEM image of the fluorinated graphene of the embodiment of the present invention, and FIG. 5B is a partial enlarged view of FIG. 5A. The structure of the fluorinated graphene of the comparative example can be clearly observed through FIGS. 4A and 4B. The thickness of the fluorinated graphene of the comparative example was analyzed to be about 5.80 nm, and the fluorinated graphene of the comparative example was a multiplayer structure. FIGS. 5A and 5B are the TEM images of the fluorinated graphene of the embodiment obtained by UV irradiation. A laminated structure can be observed through FIGS. 5A and 5B, and the thickness of which was about 2.83 nm. The fluorinated graphene of the embodiment was also a multiplayer structure. The thinner thickness of the embodiment over the comparative example demonstrates that the preparing method of the present invention utilizing the light facilitates the exfoliation of the three-dimensional layered material to form the two-dimensional material. Hence, the thickness of the exfoliated two-dimensional material can be significantly reduced in the preparing process.

### Experimental Example 3

### Exfoliating Effect Analysis of Light

The experimental example used lights having different wavelengths to irradiate the fluorinated graphite dispersions to prepare fluorinated graphene. The reaction efficiency can be determined by the color of the fluorinated graphene nanosheet suspensions.

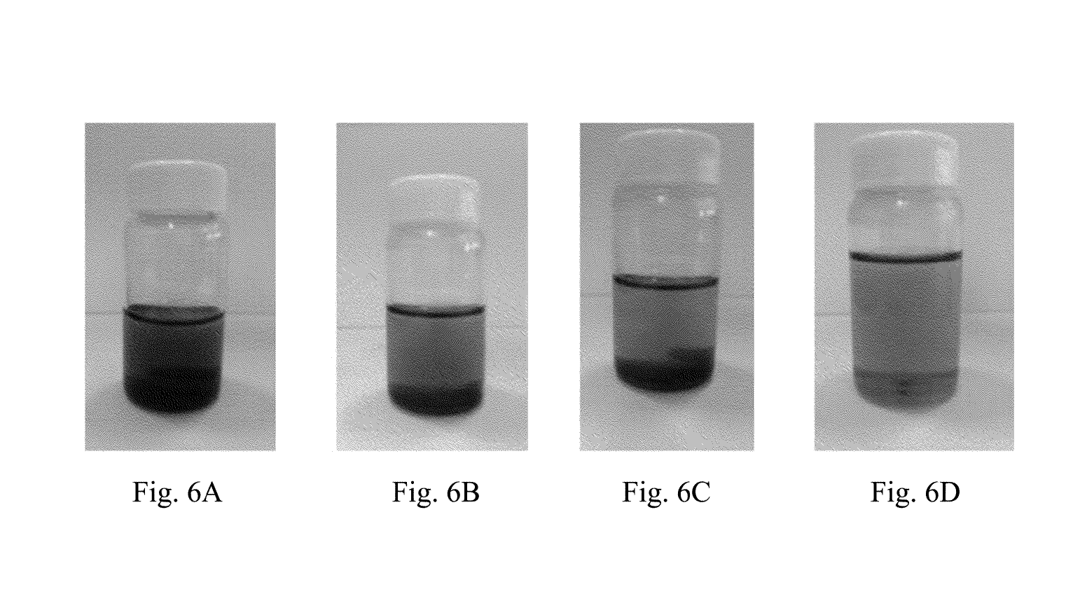

FIGS. 6A through 6D are resulting images of the fluorinated graphite dispersions irradiated by different lights. FIG. 6A shows a sample irradiated by UV, and the wavelength of which was 100-400 nm. FIG. 6B shows a sample irradiated by visible light, and the wavelength of which was 400-700 nm. FIG. 6C shows a sample irradiated by IR, and the wavelength of which was above 700 nm. FIG. 6D shows a sample not being irradiated by light. As shown in FIG. 6A, the color of the suspension containing the sample irradiated by UV obviously became darker, which the exfoliated fluorinated graphene was uniformly dispersed in the solvent. Comparing to FIG. 6D, there was clearly no exfoliation happened to the sample not being irradiated by light. Similarly, there were no obvious exfoliation happened to the samples irradiated by visible light and IR, which can be observed through FIGS. 6B and 6C. Therefore, it can be inferred that the light-induced exfoliation is related to the absorption of the fluorinated graphite. The fluorinated graphite absorbs UV, and the absorbed light energy would be converted into the molecular vibrational energy, which is beneficial to the exfoliation of the fluorinated graphite.

### Experimental Example 4

### Analysis of the Electron Collecting Efficiency

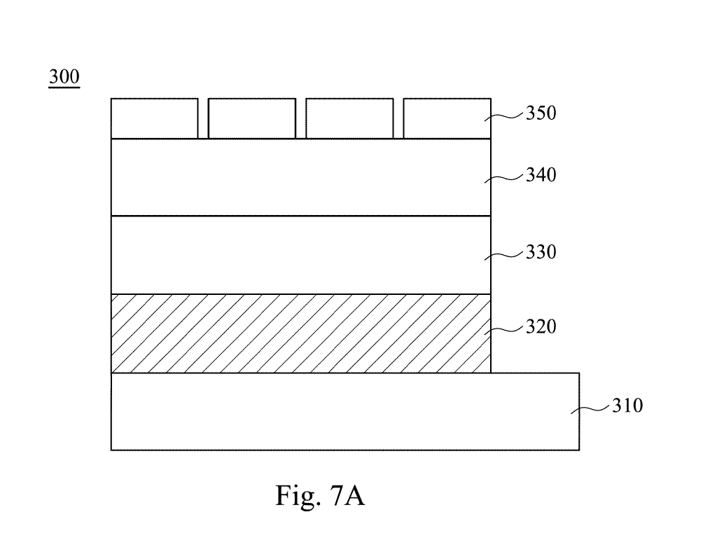

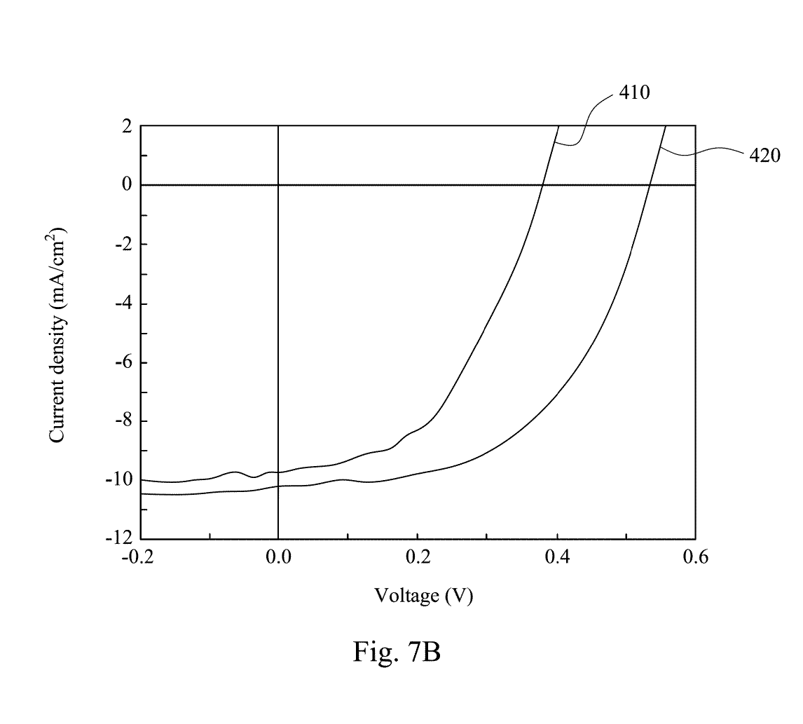

The fluorinated graphene prepared by the method for preparing the two-dimensional material of the present invention can be applied as a material of an anode buffer layer, and has an ability of transporting and/or collecting ultrasonic treatment electrons. In this experimental example, the fluorinated graphenes of the embodiment of the present invention and the comparative example were independently used as the material of the anode buffer layer of an inverted solar cell, and the device efficiency of the inverted solar cell was analyzed. FIG. 7A is a schematic structural diagram of an inverted solar cell 300. The inverted solar cell 300 includes a first electrode 310, an anode buffer layer 320, an organic active layer 330, a cathode buffer layer 340 and a second electrode 350. In this experimental example, the first electrode was an ITO electrode. The material of the organic active layer was a mixture of poly(3-hexylthiophene (P3HT) and [6,6]-phenyl C61-butyric acid methyl ester (PCBM). The material of the cathode buffer layer 340 was molybdenum trioxide (MoO₃). The second electrode 350 was a silver (Ag) electrode.

The preparing method of the inverted solar cell 300 in this experimental example include the following steps:
1. The fluorinated graphene solutions of the embodiment and the comparative example were independently spin coated on the ITO electrode 310, and heated at 150° C. for 30 minutes to form the anode buffer layer 320.
2. The mixture of P3HT and PCBM was coated on the anode buffer layer 320. After undergoing an annealing step, the organic active layer 330 was then formed.
3. The cathode buffer layer 340 was formed on the organic active layer 330.
4. Silver was vapor deposited on the cathode buffer layer 340 to form the second electrode 350.

FIG. 7B is a current density vs. voltage graph of the inverted solar cells 300 using the fluorinated graphenes of the embodiment of the present invention and the comparative example as the material of the anode buffer layer 320 independently, wherein line 410 represents the comparative example, and line 420 represents the embodiment. As shown in FIG. 7B, the inverted solar cell using the fluorinated graphene of the embodiment as the material of the anode buffer layer had better device characteristics. Comparing to the inverted solar cell using the fluorinated graphene of the comparative example as the material of the anode buffer layer, the open-circuit voltage was increased from 0.37 V to 0.53 V, and the short-circuit current was increased from 9.72 mA/cm² to 10.22 mA/cm². Accordingly, the fill factor (FF) was increased from 48.1% to 53.7%, and the power conversion efficiency was thus increased from 1.73% to 2.91%. These results suggest that the fluorinated graphene obtained by the preparing method of the present invention, which utilizes the light irradiation, has better quality, and the poor device efficiency of the inverted solar cell using the fluorinated graphene of the comparative example may be due to the thicker fluorinated graphene. The thick fluorinated graphene nanosheet of the comparative example makes the fluorinated graphene nanosheet have high resistance, which affects the electron collecting performance as the anode buffer layer.

Given the above, the method for preparing the two-dimensional material of the present invention exfoliates the three-dimensional layered material to produce monolayered or multilayered two-dimensional material. The preparing method of the present invention utilizes the manner of light irradiation. The three-dimensional layered material absorbs the light, and converts the light energy into molecular vibrational energy of each layered structure. The structure of the three-dimensional layered material thus becomes loose, and thereby exfoliating the three-dimensional layered material to produce the two-dimensional material that is a nanolevel two-dimensional material nanosheet. Comparing to conventional techniques, the two-dimensional material obtained by the preparing method of the present invention is thinner, and has advantages of a simple and rapid process, a low cost, time-saving, high efficiency, being beneficial for mass production, etc.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A method for preparing a two-dimensional material, comprising:
adding a three-dimensional layered material into a solvent to form a three-dimensional layered material dispersion; and
irradiating the three-dimensional layered material dispersion by light to exfoliate the three-dimensional layered material to produce the two-dimensional material suspending in the solvent, wherein the light has a wavelength of 100-1500 nm, and the irradiation time is 0.5-5 hours.

2. The method of claim 1, wherein the three-dimensional layered material is graphite, transition metal dichalcogenide, transition metal trichalcogenide, h-BN, transition metal halide, III-VI layered semiconductor, zirconium phosphonate, layered silicate, layered double hydroxide, ternary transition metal carbide or ternary transition metal nitride.

3. The method of claim 2, wherein the three-dimensional layered material is graphite, and the wavelength of the light is 100-400 nm.

4. The method of claim 1, wherein the solvent is N-methyl-2-pyrrolidone, N,N-dimethylformamide, 1,3-dimethyl-2-imidazolidinone, cyclohexanone, benzylamin, propylene carbonate, γ-butyrolactone or a combination thereof.

5. The method of claim 1, wherein the three-dimensional layered material dispersion has a concentration of 0.1-10 mg/mL.

6. The method of claim 1, wherein the irradiation time is 1-4 hours.

7. The method of claim 1, wherein the two-dimensional material has a thickness of 0.03-500 nm.

8. The method of claim 1, further comprising adding a surfactant to form the three-dimensional layered material dispersion.

9. The method of claim 1, further comprising adding a cosolvent to form the three-dimensional layered material dispersion.

10. The method of claim 1, further comprising a centrifuging step to separate the two-dimensional material.
